(19) United States
(12) Patent Application Publication
(10) Pub. No.: US 2005/0109579 A1
(43) Pub. Date: May 26, 2005

(54) Pallet conveyor

(76) Inventors: Jamie D. Griffin, Leonard, MI (US); George W. Bucholz, St. Clair Shores, MI (US)

Correspondence Address: WARN, HOFFMANN, MILLER & LALONE, .P.C, PO BOX 70098, ROCHESTER HILLS, MI, 48307, US

(21) Appl. No.: 10/940,925

(22) Filed: Sep. 14, 2004

Related U.S. Application Data
(60) Provisional application No. 60/504,246, filed on Sep. 19, 2003.

(51) Int. Cl. B65G 29/00

(52) U.S. Cl. 198/465.1

(57) ABSTRACT

A pallet having a coupling mechanism for use with an accumulating conveyor of the type using an endless chain having upper and lower runs driven by sprockets defining transitional portions or curvilinear chain paths. The pallet includes an upper guide bar and a lower guide bar. The lower guide bar including at least one side engagement surface having notches formed therein. Wherein, the rollers of the chain engage and are retained in the notches whereby the pallet is coupled to the chain and the chain transfers the pallet through the transitional portion or curvilinear chain path of the conveyor.

### CROSS-REFERENCE TO RELATED APPLICATION

The instant application claims priority to U.S. Provisional Patent Application Ser. No. 60/504,246 filed Sep. 19, 2003, the entire specification of which is expressly incorporated herein by reference.

### FIELD OF THE INVENTION

The present invention relates to a pallet conveyor and, more particularly, to an over and under conveyor having a mechanism for moving the pallet around the curved sections located at each end of the conveyor.

### BACKGROUND OF THE INVENTION

Pallet conveyors, sometimes referred to as accumulating conveyors or over and under conveyors, utilize an endless chain that is driven between two sprockets. Typically, loaded pallets are transported on the upper portion of the conveyor, often referred to as the upper run, and are carried back to the beginning of the conveyor on the lower portion thereof, often referred to as the lower run. The pallets travel by friction, that is, the weight of the pallet and any load thereon frictionally engages the pallet with the chain and causes the pallet to move with the chain on the upper run. The weight of the pallet creates a sufficient frictional force to transport the pallet on the lower run.

The pallets, however, must be transferred between the upper and lower runs about the curved ends of the conveyor. Accordingly, during travel about or around the curved ends of the conveyor, the pallets are typically secured or otherwise coupled to the endless chain. Various arrangements are known for operatively coupling or attaching the pallets to the chain. In some prior designs, clutches have been used. In others, an independent third gear on a shaft has been used. In still other of these prior art designs, the pallet is pinned to the chain. Securing the pallet to the chain enables the chain to drive or transport the pallet around the curved section. These arrangements provide a mechanism to lift the pallet from the lower run to the upper run, and prevent the pallets from sliding, or in effect freefalling, from the upper run to the lower run.

### SUMMARY OF THE INVENTION

The present invention is a pallet having a coupling mechanism for use with an accumulating conveyor. The pallet includes upper and lower guide bars that support the pallet during travel on the upper and lower runs of the endless chain of the conveyor. According to the present invention, the coupling mechanism includes the lower guide bar having a pair of side engagement surfaces. The side engagement surfaces having notches formed therein, whereby the lower guide bar engages the endless chain during travel about the curved sections of the conveyor to secure the pallet to the endless chain and transport the pallet about the curved ends of the conveyor.

One advantage of the present invention is that once the pallet completes its travel through the curved section of the conveyor, the side engagement surfaces of the lower guide bar lose contact or disengage from the endless chain allowing for frictional travel along either the upper or lower runs.

### BRIEF DESCRIPTION OF THE DRAWINGS

FIG. 1 is a fragmentary side view illustrating a plurality of pallets according to the present invention transported on an endless chain type conveyor;

FIG. 2 is a fragmentary view illustrating a pallet according to the present invention transported on an endless chain type conveyor;

FIG. 3 is a side view of a pallet according to the present invention shown transported on an upper run of an endless chain type conveyor;

FIG. 4 is a side view of a pallet according to the present invention shown transported on a lower run of an endless chain type conveyor;

FIG. 5 is a side view of a pallet according to the present invention shown transported on a curved section of an endless chain type conveyor;

FIG. 6 is a schematic view of the lower guide bar of a pallet according to the present invention shown engaging the endless chain;

FIG. 7 is a fragmentary, sectional side view of a pallet according to the present invention supported on the endless chain;

FIG. 8 is a fragmentary side view illustrating a plurality of pallets according to an alternate embodiment of the present invention transported on an endless chain type conveyor;

FIG. 9 is a side view of a pallet according to an alternate embodiment of the present invention shown transported on an upper run of an endless chain type conveyor;

FIG. 10 is a side view of a pallet according to an alternate embodiment the present invention shown transported on a lower run of an endless chain type conveyor;

FIG. 11 is a side view of a pallet according to an alternate embodiment of the present invention shown transported on a curved section of an endless chain type conveyor; and

FIG. 12 is a schematic view of the lower guide bar of a pallet according to an alternate embodiment of the present invention shown engaging the endless chain.

### DETAILED DESCRIPTION OF THE INVENTION

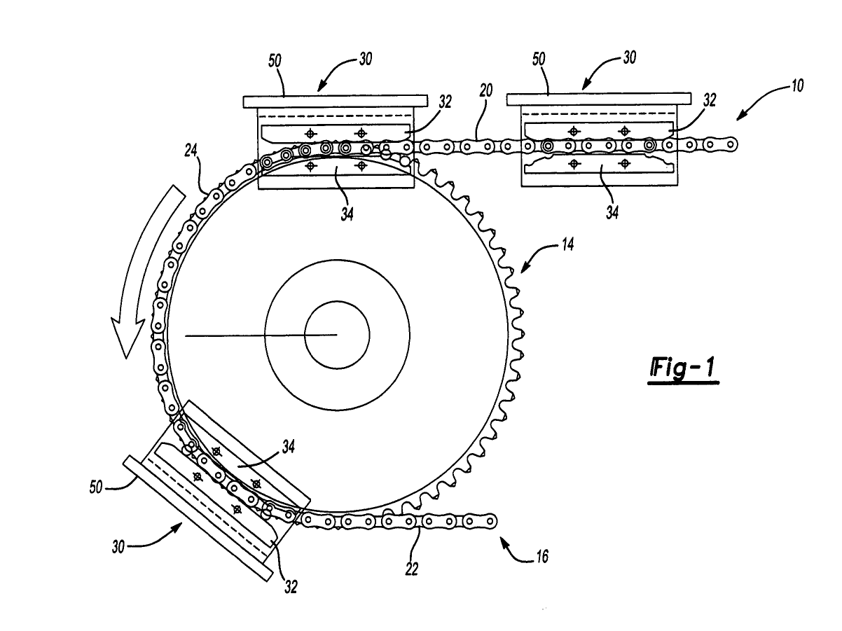

Referring now to FIGS. 1-2 and 7, an accumulating or pallet conveyor, seen generally at 10, is shown. The conveyor 10 is supported on a frame 12 including a plurality of upright members interconnected by brace members (not shown). As is known, with most accumulating or pallet conveyors the frame 12 supports sprockets 14 positioned at each end of the frame assembly 12. An endless chain 16 is positioned about the respective sprockets 14. The chain 16 progresses through a chain path having an upper portion or chain path 20, a lower portion or chain path 22 and a transitional portion or curvilinear chain path 24. The radius of curvature or specific shape of the curvilinear path 24 is defined by the sprockets 14 connecting the upper and lower chain paths 20, 22.

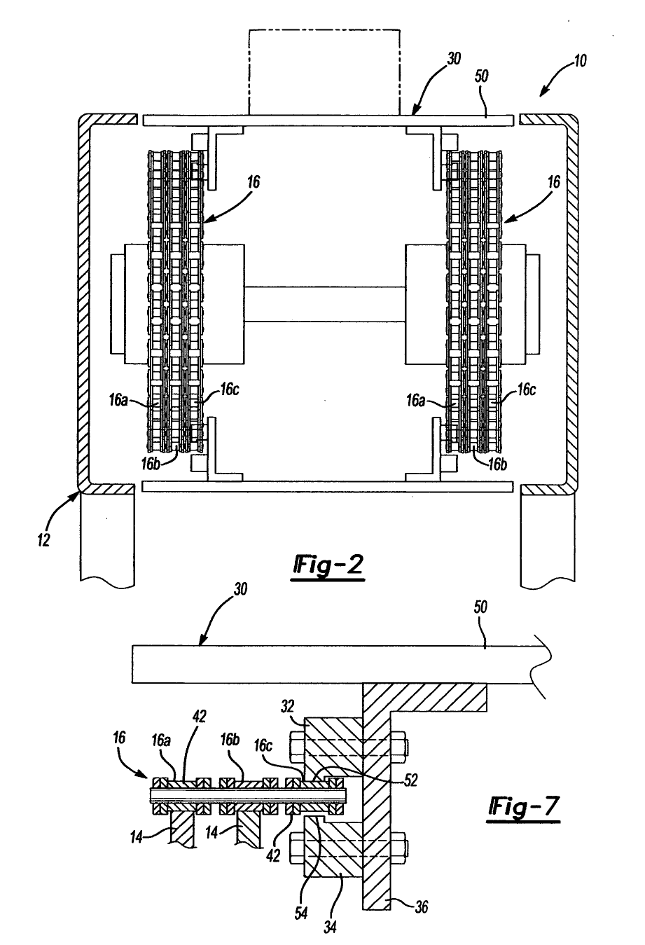

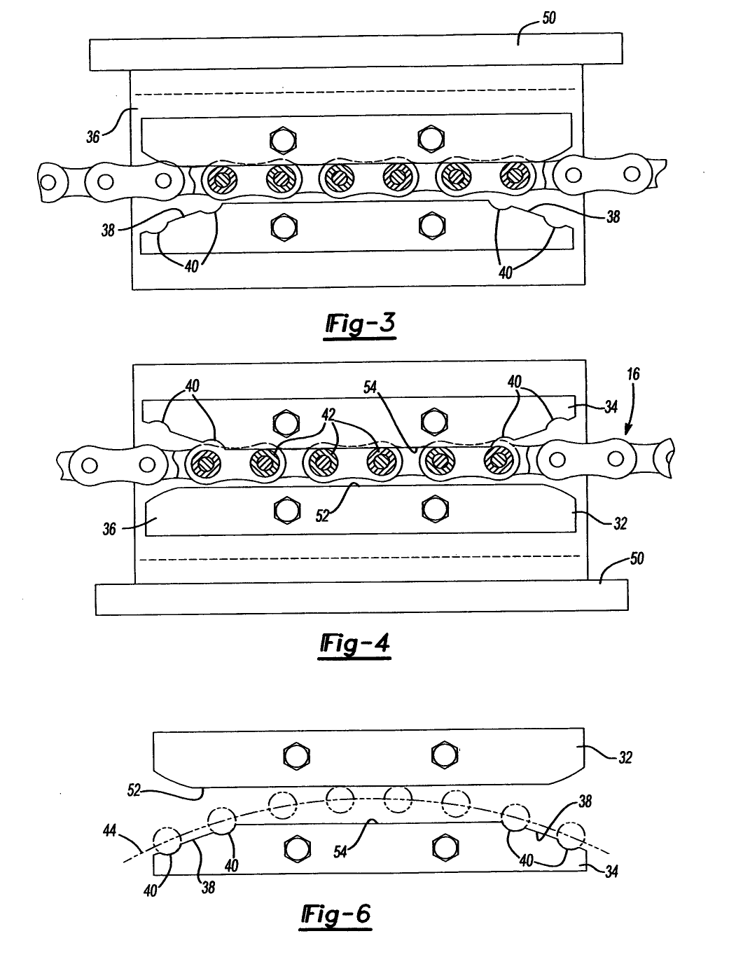

A series of pallets or article carriers 30 are shown supported on the endless chain 16 in various positions on the conveyor 10. The pallets 30 include a load supporting member 50 upon which a load to be carried by the pallet 30 is placed. As best seen in FIGS. 2, 7, the endless chain 16 comprises a triple strand chain, including three strands 16a, 16b, 16c, wherein two of the strands 16a, 16b are disposed about the sprockets 14. The third strand 16c extends inwardly from the first two strands 16a, 16b and operates in a known fashion to support the pallets or article carriers 30.

The pallets or article carriers 30 are supported on the third strand 16c, depending on the position of the pallet 30 on the chain path 18, by an upper guide bar 32 or a lower guide bar or dog 34. The upper guide bar 32 and lower guide bar 34 are connected and secured to the pallet 30 in a spaced relationship by a mounting member or support flange 36. As shown in FIGS. 1, 2 and 7, when the pallet 30 is on the upper chain path 20, it is supported on the chain 16 by a support surface 52 of the upper guide bar 32 contacting or resting on the third strand 16c of the chain 16. Thus the frictional force between the chain 16 and the upper guide bar 32, resulting from the weight of the pallet 30 and any article supported thereon, causes the pallet 30 to travel with the chain 16.

As shown in FIGS. 2, 4 when the pallet 30 is on the lower chain path 22, it is supported on the chain 16 by a support surface 54 of the lower guide bar 34 contacting or resting on the third strand 16c of the chain 16. Again, the frictional force between the chain 16 and the lower guide bar 34 causes the pallet 30 to travel with the chain 16 through the lower chain path 22.

It will be appreciated that while the pallet 30 is on the upper chain path 20 or lower chain path 22, the pallet 30 can slip relative to the chain 16. However, when the pallet 30 is in the curvilinear path 24, the pallet 30 cannot slip relative to the chain 16.

As set forth above, the transitional portion or curvilinear chain path 24 of the chain 16 extends or travels upward between the upper chain path 20 and the lower chain path 22. Initially, it is necessary to lift or drive the pallet 30 around the transitional or curvilinear path 24 from the lower chain path 22 to the upper chain path 20. This may be accomplished by coupling or connecting the pallet 30 to the drive chain 16. Also, it is advisable to connect or couple the pallet 30 to the chain 16 during movement of the chain 16 about the transitional portion or curvilinear chain path 24 that extends or travels downward between the upper chain path 20 and the lower chain path 22. Coupling the pallet 30 to the chain 16 helps to control the movement of the pallet 30 and prevent it from simply dropping downward due to the force of gravity over the downward transitional portion or curvilinear chain path 24 of the chain 16.

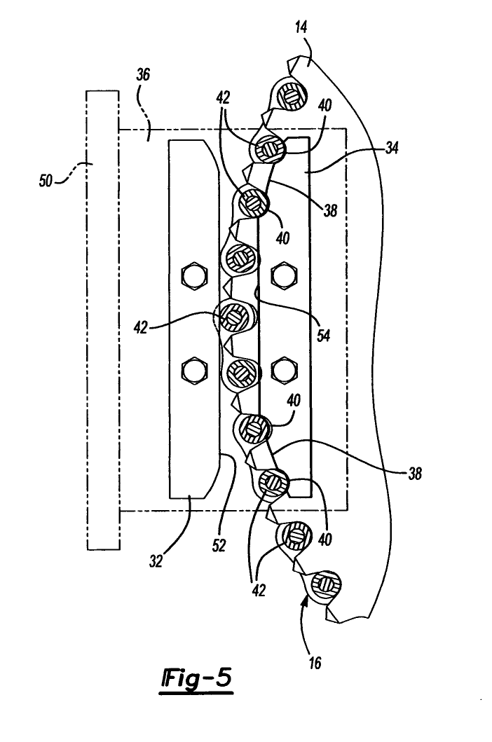

As best seen in FIGS. 5 and 6, the lower guide bar 34 has two beveled or arcuate side engagement surfaces 38. While the side engagement surfaces 38 are shown herein as part of the lower guide bar 38, they may also be separate from the lower guide bar 38 and still perform their intended function, which is to engage the endless chain 16 when the pallet 30 is positioned in the transitional portion or curvilinear chain path 24 and couple the pallet 30 on the endless chain 16 whereby it is carried or transferred by the endless chain 16 through the transition portion or curvilinear chain path 24.

A plurality of arcuate notches 40 are formed in the side engagment surfaces 38. The arcuate notches 40 typically have a radius of curvature equal to that of the rollers 42 of the chain 16. As shown in FIGS. 5 and 6, when the pallet 30 travels through the transitional portion or curvilinear chain path 24, the rollers 42 of the third strand 16c of the chain 16 engage the arcuate notches 42 on the side engagement surfaces 38. Additionally, rollers 42 of the third strand 16c of the chain engage the support surface 52 of the upper guide bar 32. Engagement of the chain 16 in this manner couples the pallet 30 to the chain 16 enabling the chain 16 to drive or carry the pallet upward from the lower run or chain path 22 to the upper portion or chain run 20 or, to control the descent of the pallet 30 from the upper run 20 to the lower run 22.

It should be understood that the upper guide bar 32 cooperates with the lower guide bar 34, specifically the side engagement surfaces 38, to maintain the rollers 42 of the chain 16 within the arcuate notches 40 located on the side engagement surfaces 38. As shown in FIG. 6, the radius 44 of the chain path 16 about the sprocket 14 is determined by the radius of the sprocket 14 and remains constant. Thus, as the pallet 30 travels about the transitional portion or curvilinear chain path 24, the chain 16 is constrained between the respective guide bars 32, 34 whereby the rollers 42 of the chain 16 engage both the lower guide bar 34 and the upper guide bar 32. Additionally, as the radius of curvature, as defined by the sprockets 14, of the chain 16, decreases, the respective length of the lower guide bar 34 will also decrease. This decrease may also include an increase in the bevel angle or a decrease in the radius of curvature of the side engagement surfaces 38. Further, the spacing between the upper guide bar 32 and lower guide bar 34 may also be varied to maintain a sufficient contact force between the chain 16 and the guide bars 32, 34 to move the pallet 30 through the transitional portion or curvilinear chain path 24.

When the pallet 30 reaches the end of the transitional portion or curvilinear path 24, the chain 16 flattens out or, resumes its linear path, whereby the pallet 30 then rests on the respective support surface of either the upper or lower guide bars 32, 34 depending on the direction of travel of the pallet 30. As set forth above, the spacing or distance between the respective support surfaces of the upper and lower guide bars 32, 34 is dependent upon the radius of curvature 44 of the chain 16. In addition, the depth, and shape of the arcuate notches 40 located in the side engagement surfaces 38, along with the angle or degree that the side engagement surfaces 38 are beveled with respect to the support surface of the lower guide bar 34 can also be varied depending upon the radius of curvature 44 along with the type and style of chain 16.

It should be understood that the above mechanism provides an efficient manner of coupling or connecting a pallet 30 to a chain 16 of a conveyor 10 to control and effect movement of the pallet 30 through the transitional portion or curvilinear chain path 24 of the conveyor 10.

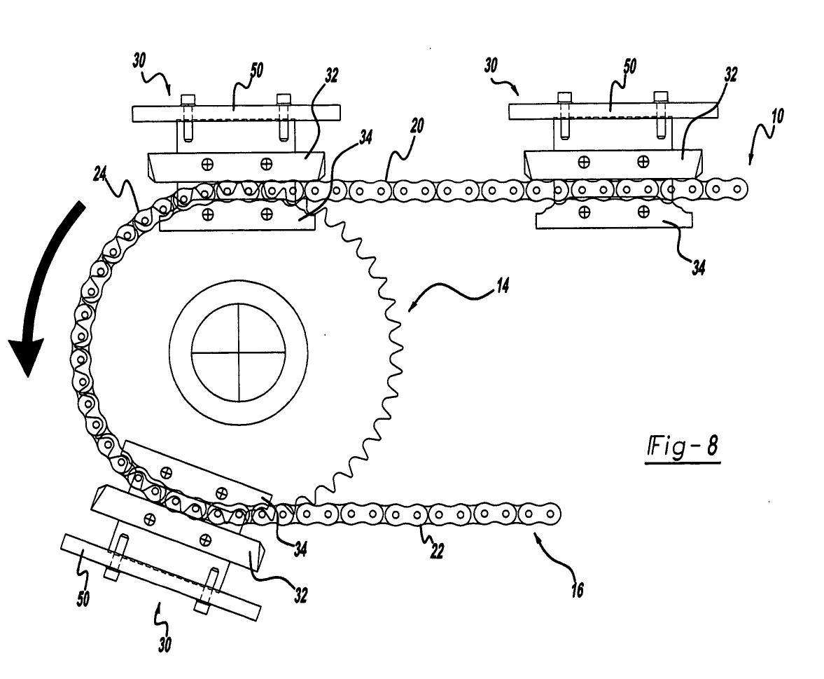

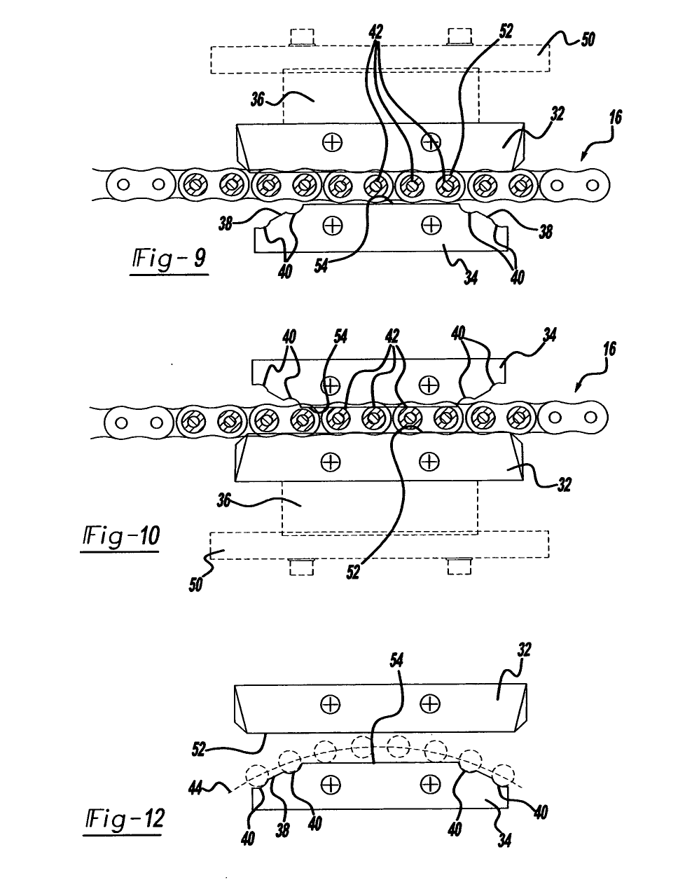

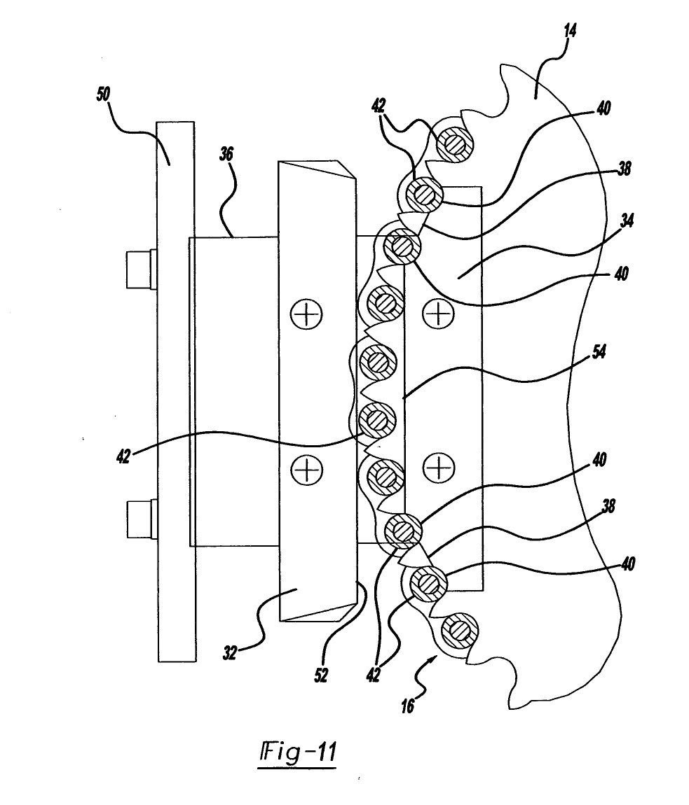

FIGS. 8-12 show an alternate embodiment having a alternate arrangement of the support flange 36 and the load supporting member 50. These Figures also show a different size lower guide bar 32 for use with a sprocket of different radius. FIG. 9 also shows that there may be a gap, preferably of about 1/32 inch between the upper guide bar 32 and the roller 42. This gap helps to alleviate binding of the upper guide bar 32. The gap, however, should not be so large as to allow the side engagement surfaces 38 of the lower guide bar 32 to disengage from the chain 16.

It will thus be seen that the objects of the invention have been fully and effectively accomplished. It will be realized, however, that the foregoing specific embodiments have been shown and described for the purposes of illustrating the functional and structural principles of the invention and is subject to change without departure from such principles. Therefore, this invention includes all modifications encompassed within the scope of the following claims.

1. A pallet for use with a conveyor of the type using an endless chain, said the pallet comprising:
a load bearing member;
a mounting member secured to said load bearing member;
and upper guide bar, including a support surface, said upper guide bar secured to said mounting member; and
a lower guide bar secured to said mounting member, said lower guide bar including a support surface and at least one side engagement surface.

2. The pallet as set forth in claim 1 including said side engagement surface having a notch therein.

3. The pallet as set forth in claim 1 wherein said lower guide bar includes at least two side engagement surfaces, each of said side engagement surfaces having at least one notch thereon.

4. The pallet as set forth in claim 2 wherein said side engagement surface is beveled with respect to said support surface of said lower guide bar.

5. The pallet as set forth in claim 2 wherein said side engagement surface is arcuate.

6. The pallet as set forth in claim 2 when said notch is arcuate.

7. A pallet for use with an accumulating conveyor of the type having an endless chain driven, between two sprockets, through an upper chain path, a lower chain path and a curvilinear chain path, the pallet comprising:
a load bearing member;
a mounting member secured to said load bearing member;
an upper guide bar secured to said mounting member; and
a lower guide bar secured to said mounting member, said lower guide bar including at least one side engagement surface, said lower guide bar spaced from said upper guide bar a distance such that when said the pallet is positioned on the curvilinear chain path, said endless chain contacts both the side engagement surface of said lower guide bar and a support surface of said upper guide bar.

8. The pallet as set forth in claim 7 wherein said lower guide bar includes at least two side engagement surfaces, wherein when said the pallet is positioned on the curvilinear chain path, said endless chain contacts each of said side engagement surfaces and a support surface of said upper guide bar.

9. The pallet as set forth in claim 7 wherein said lower guide bar includes said side engagement surface having a notch formed therein, said in notch operative to contact the endless chain when said endless chain contacts said side engagement surface.

10. The pallet as set forth in claimed 7 wherein said side engagement surface is arcuate.

11. The pallet as set forth in claim 7 wherein said side engagement surface is beveled with respect to a support surface of said lower guide bar.

12. The pallet as set forth in claim 8 wherein said side engagement surfaces each having at least one notch located thereon, said notch operative to engage said chain when said chain contacts said side engagement surfaces of said lower guide bar.

13. A pallet for use with an accumulating conveyor of the type having an endless chain driven, between two sprockets, through an upper chain path, a lower chain path and a curvilinear chain path, the pallet comprising:
a load supporting member;
a mounting member secured to said load supporting member;
an upper guide bar secured to said mounting member, said upper guide bar having a support surface;
a lower guide bar secured to said mounting member in a spaced relationship with said upper guide bar, said lower guide bar having a support surface, said support surface of said lower guide bar positioned opposite and facing said support surface of said upper guide bar;
a side engagement surface located adjacent said support surface of said lower guide bar wherein when said the pallet is positioned on the curvilinear chain path, said endless chain contacts both said side engagement surface and said support surface of said upper guide bar.

14. The pallet as set forth in claim 13 including a plurality of side engagement surfaces located adjacent said support surface of said lower guide bar, each of said side engagement surfaces having a notch formed therein, said notch operative to contact a roller of the endless chain when the endless chain contacts said side engagement surfaces.

15. The pallet as set forth in claim 13 wherein said side engagement surfaces are positioned on opposite sides of said support surface of said lower guide bar, the distance between said respective side engagement surfaces and the spacing between said support surface of said upper guide bar and said lower guide bar dependent upon the radius of curvature of the curvilinear chain path.

16. The pallet as set forth in claim 15 including each of said side engagement surfaces having a notch formed therein, said notch operative to contact a roller of the endless chain when the endless chain contacts said side engagement surfaces.

17. The pallet as set forth in claim 16 or end said side engagement surfaces are beveled with respect to said support surface of said lower guide bar.

18. The pallet as set forth in claim 16 wherein said side engagement surface is arcuate.

19. The pallet as set forth in claim 13 wherein said side engagement surface is formed on said lower guide bar adjacent said supporting surface of said lower guide bar.

20. The pallet as set forth in claim 13 wherein said lower guide bar includes side engagement surfaces located on opposite sides of said support surface of said lower guide bar, said side engagement surfaces having an arcuate notch therein, said arcuate notch contacting a roller of said endless chain said endless chain contacts both said side engagement surfaces and a support surface on said upper guide bar.
